(19) United States
(12) Patent Application Publication
(10) Pub. No.: US 2022/0170499 A1
(43) Pub. Date: Jun. 2, 2022

(54) STRUCTURAL FUSE

(71) Applicant: AIRBUS OPERATIONS LIMITED, Bristol (GB)

(72) Inventor: Fraser WILSON, Bristol (GB)

(21) Appl. No.: 17/508,719

(22) Filed: Oct. 22, 2021

(30) Foreign Application Priority Data
Nov. 30, 2020 (GB) 2018805.8

(51) Int. Cl. F16B 31/02; B64C 25/00; B64C 25/34

(52) U.S. Cl. CPC F16B 31/021; B64C 25/34; B64C 25/001

(57) ABSTRACT

A structural fuse is disclosed and configured to shear upon an application of a predetermined load and includes a plurality of elongate reinforcing elements in a metal matrix. The provision of a so-called metal matrix composite results in a fuse that is lighter in weight than a conventional metal pin and has improved fatigue properties and hence a longer operating life. The load (or range of loads) at which the fuse is arranged to shear can be engineered by careful arrangement of the orientation of the reinforcing elements, and by selecting the proportion of reinforcing elements in the matrix. Thus, a fuse having a narrower load range than hitherto achievable can be produced.

### FIELD OF TECHNOLOGY

This invention relates to a structural fuse, such as may be found on an aircraft or aircraft-supporting equipment. The invention further relates to a component of an aircraft, or of aircraft-supporting equipment, including such a structural fuse. The invention also relates to a method of making such a structural fuse.

### BACKGROUND

A structural fuse is a component intended to provide a point of failure at a predetermined load, in an effort to prevent damage to other components. Structural fuses can take many forms; when in the form of a pin they are also known as fuse pins, shear pins or breakaway pins. Structural fuses are typically employed in agricultural and industrial machinery, in power tools, in buildings and in vehicles, such as aircraft.

For example, a structural fuse in the form of a fuse pin typically forms part of the connection between an aircraft landing gear beam and the aircraft wing. If the aircraft has a particularly hard landing, or the landing gear impacts an object, the fuse pin is configured to shear if the load it experiences is at or above a predetermined value. The shearing of the fuse pin may dissipate energy and prevent other components from being damaged due to the hard landing and/or impact. For example, the shearing of the fuse pin may help to prevent damage to the fuel tanks on the wing of the aircraft.

A landing gear fuse pin typically has a main body in the form of a metal cylinder, with the cross section of the internal bore being designed so that the fuse pin breaks at a predetermined load and, preferably, at a predetermined location on the pin.

The cyclic loading experienced by a fuse pin in use can result in fatigue cracks and, consequently, an undesired failure of the pin. Thus, a fuse pin may have a relatively short operational life. It has been proposed to reduce fatigue failures by increasing the size of the pin. However, a problem which may be encountered with this approach is that the components that the fuse pin attaches to need to be strengthened accordingly, as do the parts that those components attach to, and so on. This snowball effect can result in considerable excess weight being added to the aircraft.

### BRIEF SUMMARY OF THE TECHNOLOGY

The invention provides a structural fuse configured to shear upon an application of a predetermined load and having a longitudinal axis, the fuse comprising a plurality of longitudinal reinforcing elements in a metal matrix. The provision of such a so-called metal matrix composite results in a fuse having improved fatigue properties and hence a longer operating life.

Advantageously, at least some of the reinforcing elements are arranged substantially parallel to the longitudinal axis, so that the fuse is stronger along its longitudinal axis but not heavier than a conventional fuse.

At least some of the reinforcing elements may be arranged transverse to the longitudinal axis, for example in a helical formation. At least some of the longitudinal reinforcing elements may be arranged substantially perpendicular to the longitudinal axis, for example as hoops. The load (or range of loads) at which the fuse is arranged to shear can be engineered by careful arrangement of the orientation of the reinforcing elements, and by selecting the proportion of fibres in the matrix. Thus, a fuse having a narrower load range than hitherto achievable can be produced.

Preferably, at least a portion of the metal matrix may comprise a plurality of hollow metal ceramic spheres. This results in a foam-like material that can absorb higher loads than a solid metal fuse.

The matrix material may comprise a selection of, or a combination of, the following: aluminium; titanium; steel, copper; nickel; any alloy of the aforementioned metals; and metal ceramics material.

The reinforcing elements may include ceramic fibres, such as aluminium oxide fibre or silicon carbide fibre. Carbon fibres may also be employed.

A structural fuse constructed according to the invention may take the form of a fuse pin. The pin may have an internal bore along at least part of the longitudinal axis. The bore may have a predetermined profile so that it shears at a predetermined location.

The invention also provides an aircraft component, such as a landing gear assembly including such a structural fuse, and an aircraft including such a component.

The invention further provides aircraft supporting equipment, such as the tow bar of an airport vehicle, including such a structural fuse.

A further aspect of the invention provides a method of manufacturing such a structural fuse, comprising the steps of: arranging longitudinal reinforcing elements in a predetermined configuration; introducing a matrix material around the reinforcing elements such that the matrix material at least partially surrounds the reinforcing elements; and solidifying the matrix material.

The first step of this method advantageously comprises arranging the longitudinal reinforcing elements as a predetermined fraction of the fuse and in predetermined orientations. Thus, the load band or range of load values at which shearing of the fuse occurs can be more precisely engineered and made narrower if desired.

The first step may also include arranging a plurality of metal ceramic spheres in a predetermined configuration. The spheres may be vibrated to distribute them.

### BRIEF DESCRIPTION OF THE DRAWINGS

The invention will now be described, by way of example, with reference to the accompanying drawings in which:

FIG. 1 is a side sectional view through a structural fuse constructed according to the invention;

FIG. 2 is a side sectional view of a structural fuse constructed according to an alternative embodiment of the invention;

FIG. 3 is a side sectional view of a structural fuse constructed according to another alternative embodiment of the invention;

FIG. 4 is a side sectional view of a structural fuse constructed according to a further alternative embodiment of the invention;

FIG. 5 is a schematic diagram of a process for manufacturing any of the structural fuses of FIGS. 1-4;

FIG. 6a is a perspective view showing a structural fuse constructed according to the invention in part of an aircraft landing gear assembly; and

FIG. 6b is an enlarged drawing of part of the assembly of FIG. 6a.

Like reference numerals refer to like parts throughout the specification.

### DETAILED DESCRIPTION OF EMBODIMENTS OF THE TECHNOLOGY

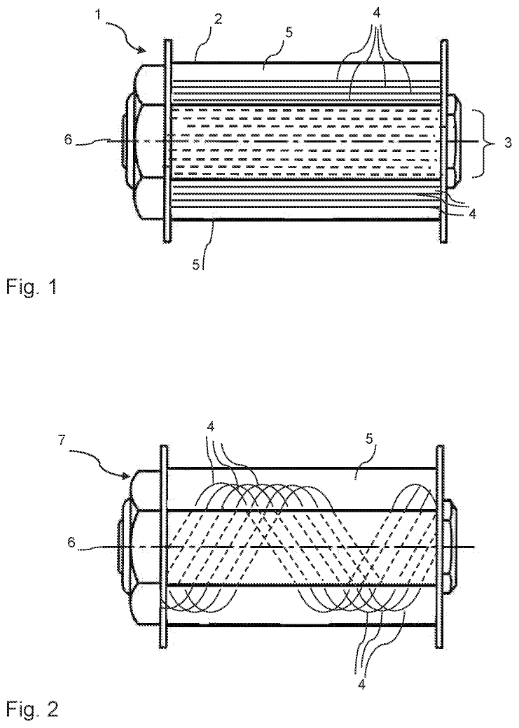

A structural fuse in the form of a fuse pin constructed according to the invention is shown schematically in FIG. 1 and indicated generally by the reference numeral 1. The pin 1 comprises a generally cylindrical main body 2 having a hollow interior region 3. In this drawing, the cylindrical main body 2 is shown as having a simple, straight-sided interior wall for simplicity. In practice, the interior surface of the cylindrical main body 2 may be arranged to have a predetermined profile, so that the hollow region 3 is larger in some areas than others. Thus, the location of shear in the fuse pin 1 can be engineered as required. In accordance with the invention, the fuse pin 1 comprises a plurality of elongate reinforcing elements 4 in the form of long fibres, embedded in a metal matrix 5. In this embodiment, the reinforcing elements 4 extend axially along the fuse pin: the pin has a longitudinal axis 6 and the reinforcing elements are arranged substantially parallel to that axis.

In these drawings, only a few reinforcing elements are shown for clarity. The number of reinforcing elements employed will typically be greater than is shown here.

An “elongate” element is any structure having one dimension that is significantly longer than any other dimension. For example wires, fibres, tapes, threads and the like are all considered to be elongate elements.

The elongate reinforcing elements 4 may comprise, for example, ceramic fibres such as aluminium oxide fibres or silicon carbide fibres. The matrix material 5 is a metallic material, such as aluminium, titanium, or any other suitable metallic material. It is anticipated that the volume of matrix material 5 will be significantly larger than the volume of reinforcing elements 4 in the fuse pin 1, so the overall cost, weight and machinability of the component is largely determined by the choice of matrix material.

It has been found that such a metal matrix composite material has improved fatigue properties. Thus, the fuse pin 1 manufactured of this material has a significantly improved operational life, which can be achieved without adding to the weight of the pin. In fact, the pin 1 can be made lighter in weight than a conventional fuse pin, which is typically of steel. Thus, employing the fuse pin 1 results in no additional weight having to be added to the supporting components of the aircraft, with consequent fuel savings and reduced emissions.

It should be noted that the shearing load and/or shearing location of a fuse pin constructed according to the invention can be tailored or tuned in a variety of ways, some of which are discussed below. The key to success in producing a structural fuse is the close setting of a narrow load band in which rupture of the fuse can be guaranteed. The strength of a structural fuse constructed according to the invention is a function of both the fibre fraction and fibre orientation, and the setting of the load band can be achieved more accurately than was possible hitherto. Thus, the invention allows for structural fuses to be made for a wide variety of applications and working environments.

For example, FIG. 2 shows an alternative fuse pin 7 constructed according to the invention. In this example, the fuse pin 7 comprises a plurality of elongate reinforcing elements in the form of long fibres 4 in a metal matrix 5 as before. However, the direction of the fibres 4 is transverse to the longitudinal axis 6 of the pin. In this embodiment, the fibres 4 are at an angle of approximately 45° to the axis 6; the fibres 4 form a helical winding along the fuse pin 5. Such a helicoidal arrangement of fibres makes for a greater compressive strength and shear resistance of the fuse pin 7.

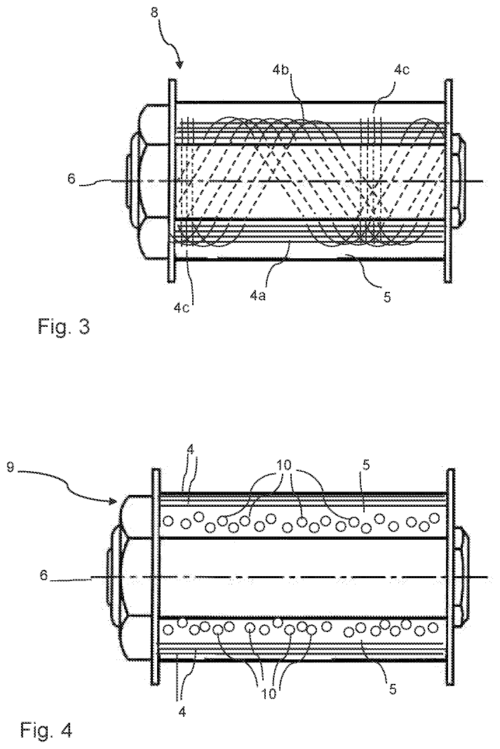

In the alternative fuse pin 8 of FIG. 3, a first portion 4a of the fibres 4 are aligned with the longitudinal axis 6 of the pin. A second portion 4b of the fibres are helically wound, so as to form an angle of around 45° to the axis 4. A third portion 4c of the fibres 4 is arranged at a normal to the longitudinal axis 6 i.e. the fibres form hoops around the axis. Such an arrangement is suitable for fuse pins arranged to shear at relatively high loads. The hoop portions 4c of the fibres 4 may be arranged in regions of the fuse pin 8 requiring greater reinforcement i.e. at locations that are not intended to shear on application of a load.

Thus, the shearing threshold, location of shear and direction of shearing load of the fuse pin can be tailored by employing different orientations of fibres in the pin. The diameter of the fibres, the material of the fibres and the proportion of fibres in the matrix all influence the shearing properties of the pin.

Different regions of the pin may have fibres of different size, material and fibre fraction in the matrix, in dependence on the desired properties of the pin. In an application where the pin is arranged to shear at a relatively low load, the desired point of shear in the pin may be arranged to have a low density of reinforcing elements 4, or no reinforcing elements at all.

The properties of the fuse pin may also be tailored for the application of the pin by adjusting the properties of the metal matrix. For example, the material of the matrix may be chosen to best suit the operating environment of the pin, or different materials may form the matrix in different regions of the pin.

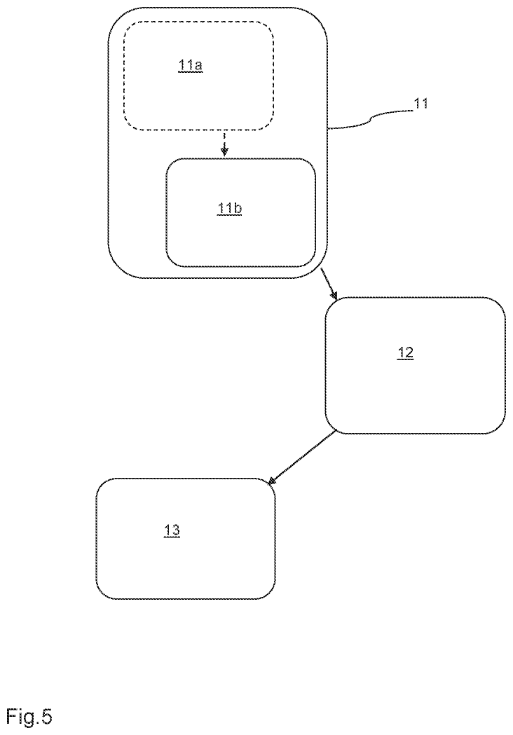

Another way in which the properties of the pin may be adjusted is shown in FIG. 4. In this embodiment, the fuse pin 9 comprises a plurality of long fibre reinforcing elements 4 in a metal matrix 5, as before. In this embodiment a region of the metal matrix 5 includes a plurality of hollow metal ceramic spheres 10. The combination of spheres 10 in the metal matrix 5 forms a foam-like arrangement that can absorb large amounts of impact energy by its sacrificial collapse through buckling and cracking of the spheres. The fuse pin 9 can thus absorb higher levels of energy than a conventional purely metal fuse pin. The fuse pin 9 has good strength, under both tension and compression, reduced thermal conductivity and is lighter in weight than a conventional pin.

In this drawing, the spheres 10 are shown as being distributed evenly along the longitudinal axis 6, but of course the spheres may be arranged to form different fractions of the metal matrix in different regions of the pin, in dependence on the desired location of shear and shearing load. The spheres 10 may be of any diameter in the range of micrometres to millimetres. They may all be of substantially the same diameter or a selection of a range of diameters. The spheres 10 may be of one material, such as alumina or silica carbide, or a plurality of different materials in the same composition. The spheres 10 may be coated to enable easier integration with the metal matrix.

FIG. 5 is a flow chart illustrating an example method of manufacturing a structural fuse constructed according to the invention. Such a structural fuse may be, for example, any of the example fuse pins discussed above. Optional steps i.e. steps which apply only to certain embodiments of the invention, are shown in broken lines.

In one embodiment of a casting method according to the invention, the first step 11 comprises “laying up” of the reinforcing elongate elements and, where used, the hollow metal ceramic spheres. Firstly, the spheres 10 are placed inside the mould (optional step 11a). The hollow spheres may be arranged inside the mould, such as through vibrating, to pack the spheres into a best attainable close-packed density. Once the spheres are packed in the mould, the elongate reinforcing elements 4 are added to the mould (step 11b). This may be done by simply laying fibres within the mould, or else by winding fibres around one of more support structures, which may be formed in the casting mould itself. The fibres may be conveniently embedded in a fabric or tape that can simply be laid on, or wound around, a mandrel. A bundle of elongate elements may be simultaneously wound around a mandrel to form a plurality of loops. Alternatively, a single elongate element may be wound multiple times until a desired number of loops is formed. A plurality of elongate elements may be pre-woven or braided into an interlinked arrangement before being arranged on the mandrel. The laying of the elongate elements may be performed manually, or using an automated tool. Any technique known for arranging fibres in the manufacturing of carbon fibre reinforced plastic (CFRP) components may be used to arrange the elongate elements 4.

The next step 12 in the manufacturing process is that of introducing the metal matrix material 5. One way in which this can be done is by pouring liquid metal into the mould. In this embodiment, the mould incorporating the spheres and reinforcing material is first pre-heated. Preferably, the pre-heat temperature is approximately equal to the casting temperature of the matrix-forming liquid metal in order to prevent premature solidification of the matrix before complete filling of the mould.

The matrix-forming liquid metal is cast into the mould in such a manner as to fill the voids around the hollow spheres 10 and reinforcing elements 4 while avoiding disturbance of the spheres and reinforcing elements within the mould. In some embodiments, it may be useful to use screens, pegs, wax binders or other similar means, for maintaining the arrangement of the spheres and reinforcing elements within the mould. In addition to gravity casting, the mould may be subject to pressure differentials during the cast process. For example, the mould may be pressurised or held under vacuum.

Once the matrix-forming liquid metal has been satisfactorily cast into the mould, the liquid metal is solidified (step 13) to form a solid metal matrix around the hollow spheres 10 and reinforcing elements 4. Such solidification is generally through cooling of the mould, which can be through atmospheric cooling or through more controlled cooling methods.

In other examples, an additive manufacturing process may be used to arrange the matrix material on the reinforcing member. In such examples a mould is not required. Instead the matrix material is built up layer wise around and on the reinforcing elements (and optionally the metal ceramic spheres), according to a predetermined design corresponding to the desired shape of the component. Any suitable additive manufacturing process known in the art could be used, depending on the type of the matrix material. An additive manufacturing process used to arrange the matrix material on the reinforcing member would be tailored such that the arrangement of the reinforcing elements and/or metal ceramic spheres is not disturbed (either physically or chemically) during deposition of the matrix material. Various alternative techniques could also be used to introduce the matrix material including (but not limited to) electron beam deposition, laser deposition, and hot isostatic pressing (HIP).

The fuse pin may be formed by other suitable processes known to the skilled person, such as powder metallurgy, squeeze casting or diffusion bonding.

In the case where it is desired for the internal surface of the pin to have a predetermined profile, this can be done at the casting stage by, for example, using a mandrel having a desired profile. Alternatively, the profile can be machined into the pin after the solidification step described above.

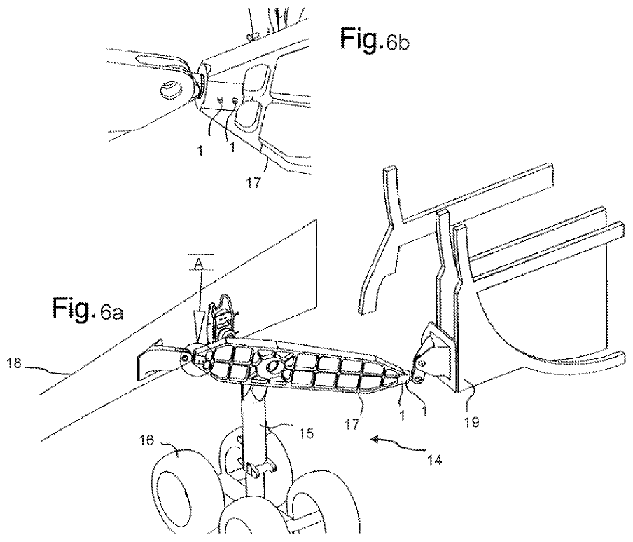

FIGS. 6a and 6b show a fuse pin constructed according to the invention in part of a main landing gear assembly 14 of an aircraft. FIG. 6b is an enlarged view of the region marked A in FIG. 6a. The fuse pin 1 constructed according to the first embodiment is shown, but any of the fuse pins 7, 8, 9 or any other alternative embodiment may be employed. Some of the components of the landing gear assembly are not shown in this drawing for clarity.

The main landing gear assembly 14 comprises an oleo strut 15 having a wheel assembly 16 at one end. At the other end of the oleo strut 15 is a landing gear beam 17. One end of the landing gear beam 17 is connected to the rear spar 18 of a wing. As shown in FIG. 7b, the connection between the landing gear beam 17 and the spar 18 includes two fuse pins 1 constructed according to the invention. A further pair of fuse pins 1 is provided in the connection between the other end of the landing gear beam 17 and the aircraft fuselage 19. The fuse pins 1 prevent rotation of the gear beam 17 in normal operating conditions. Upon the application of an excessive rearward force to the oleo strut 15, possibly by the wheel assembly 16 striking an object during take-off or landing, the strut will be urged to rotate about the longitudinal axis of the gear beam 17 whereupon the fuse pins 1 will shear to allow rotation to take place for safe disengagement of the landing gear from the beam, without damage to the spar 18 and consequently the wing.

A fuse pin constructed according to the invention may also be employed in other aircraft assemblies, such as on the connection between an aircraft engine and its pylon, and/or between the pylon and a wing. The structural fuse on an aircraft may also take the form of a lug, strut or brace.

A structural fuse constructed according to the invention may also be employed in aircraft-supporting equipment. For example, a structural fuse in the form of a fuse pin may form part of a tow bar connection used by ground vehicles to move an aircraft around the airport. If the aircraft hits an obstacle during towing, the fuse pin ruptures to prevent damage to the aircraft. In this application, the fuse pin may be of a solid metal matrix composite material, without the hollow interior region.

Structural fuses constructed according to the invention may also be employed in a wide variety of environments and applications. For example, a fuse pin may form part of the attachment between a drive and a gearbox in industrial or agricultural machinery. A fuse pin may be employed in ships, in the connection between a propeller and a marine engine, in order to protect the engine if the propeller strikes an underwater object. In construction, certain regions of a building or bridge may be designed with structural fuses in the form of beams that are arranged to buckle and fail in a controlled way and hence dissipate energy during a high-intensity seismic event. Further uses of the invention will be apparent to the person skilled in the art.

Other fibres suitable for use in a structural fuse constructed according to the invention include galvanic-coated carbon fibres, basalt fibres, boron fibres, basalt fibres, or any other high strength fibres. Other suitable matrix materials include alloys of titanium, aluminium, steel, copper and nickel, and metal ceramics materials. Further variations of the invention will be apparent to the person skilled in the art.

1. A structural fuse configured to shear upon an application of a predetermined load and having a longitudinal axis, the pin comprising a plurality of elongate reinforcing elements in a metal matrix.

2. A structural fuse as claimed in claim 1, in which at least some of the reinforcing elements are arranged substantially parallel to the longitudinal axis.

3. A structural fuse as claimed in claim 1, in which at least some of the reinforcing elements are arranged transverse to the longitudinal axis.

4. A structural fuse as claimed in claim 1, in which at least some of the elongate reinforcing elements are arranged substantially perpendicular to the longitudinal axis.

5. A structural fuse as claimed in any previous claim 1, in which at least a portion of the metal matrix comprises a plurality of hollow metal ceramic spheres

6. A structural fuse as claimed in claim 1, wherein the matrix material comprises a selection of: aluminium; titanium; steel, copper; nickel;
any alloy of the aforementioned metals; and metal ceramics material.

7. A structural fuse as claimed in claim 1, wherein the reinforcing elements include ceramic fibres.

8. A structural fuse as claimed in claim 7, wherein the ceramic fibres comprise aluminium oxide fibre or silicon carbide fibre.

9. A structural fuse as claimed in claim 1, wherein the reinforcing elements include carbon fibres.

10. A structural fuse as claimed in claim 1 in the form of a fuse pin.

11. A structural fuse as claimed in claim 10, in which the pin has an internal bore along the longitudinal axis having a predetermined profile.

12. An aircraft component including a structural fuse as claimed in claim 1.

13. An aircraft including a component as claimed in claim 12.

14. Aircraft supporting equipment including a structural fuse as claimed in claim 1.

15. A method of manufacturing a structural fuse as claimed in claim 1, the method comprising the steps of: arranging elongate reinforcing elements in a predetermined configuration; introducing a matrix material around the reinforcing elements such that the matrix material at least partially surrounds the reinforcing elements; and solidifying the matrix material.

16. A method as claimed in claim 15, in which the first step comprises arranging the elongate reinforcing elements as a predetermined fraction of the fuse and in predetermined orientations.

17. A method of manufacturing a structural fuse as claimed in claim 15, in which the first step also includes arranging a plurality of metal ceramic spheres in a predetermined configuration.

18. A method as claimed in claim 17, further comprising the step of vibrating the spheres to distribute them.
